(19) United States
(12) Patent Application Publication
(10) Pub. No.: US 2010/0237568 A1
(43) Pub. Date: Sep. 23, 2010

(54) Radial Shaft Seal and Radial Shaft Sealing System

(76) Inventors: Siegmar Kreutzer, Heerlen (NL); Franz Pawellek, Lauteral/ OT Oberlauter (DE)

Correspondence Address: CAHN & SAMUELS LLP, 1100 17th STREET NW, SUITE 401, WASHINGTON, DC, 20036, US

(21) Appl. No.: 12/665,650

(22) PCT Filed: Jun. 19, 2008
(86) PCT No.: PCT/EP08/57765

§ 371 Date: Jun. 3, 2010

(30) Foreign Application Priority Data
Jun. 20, 2007 (DE) 20 2007 008 740.3

(51) Int. Cl. F16J 15/32

(52) U.S. Cl. 277/564

(57) ABSTRACT

A radial shaft seal for sealing a closed inner chamber (K), filled with a fluid medium (M), on a rotating shaft (W) that is guided out of the inner chamber (K) through a receiving opening (2), relative to an external atmosphere (A), has two membrane bodies (3, 4), each having a sealing membrane (5) having a sealing lip (6) positioned obliquely to the inner chamber (K), where the two sealing lips (6) can be positioned on the shaft (W) in sealing fashion at an axial distance from each other, and a supporting device (7) for supporting the membrane bodies (3, 4) resting thereon. To improve the service life and reduce the internal pressures, it is proposed that the two membrane bodies (3, 4) be positioned at a distance from each other over their entire course, and that the supporting device (7) includes a supporting body (8) located between the membrane bodies (3, 4).

The invention relates to a radial shaft seal for sealing a closed inner chamber, filled with a fluid medium, on a rotating shaft that is guided out of the inner chamber through a receiving opening, relative to an external atmosphere, the seal comprising two membrane bodies, each having a sealing membrane having a sealing lip positioned obliquely to the inner chamber, where the two sealing lips can be positioned on the shaft in sealing fashion at an axial distance from each other, and a supporting device for supporting the membrane bodies resting thereon. The invention further relates to a radial shaft sealing system involving the radial shaft seal.

DE 20 2006 003 897.3 describes a generic radial shaft seal, where the sealing membranes are supported by the supporting device on the side facing away from the inner chamber, and the supporting device and the shaft in each case form a gap assigned to a sealing membrane. This entails the risk of eccentricity between the opening of the supporting part and the shaft in the opening of the supporting part, and thus of extrusion of the sealing membrane into the gap when exposed to pressure, this reducing the service life of the radial shaft seal.

EP-A-706 001 describes a radial shaft seal in which the sealing membrane is supported against the pressure of the fluid medium in the inner chamber by a supporting device that can include an axially fixed disk with a central opening, through which the shaft passes at a distance from the edge of the opening. The edge resting on the shaft is designed as a sealing lip positioned obliquely to the inner chamber, as a result of which a sealing effect due to positive internal pressure is intensified.

A further radial shaft seal of this kind is known from WO-A-02/052180. It comprises a first membrane body with a sealing membrane that rests on the shaft with a sealing lip positioned obliquely to the inner chamber.

Prior to first-time filling of the inner chamber with a fluid, particularly in cooling systems where coolants are used as the fluid, the inner chamber is customarily evacuated by means of a suction pump to check the system for leaks, in which context the lowest possible negative pressure is targeted for efficient leak testing. In this respect, DE 20 2006 003 897.3 describes very low achievable pressures. WO-A-02/052180 proposes use of a third sealing membrane with a sealing lip positioned obliquely outwards, this being intended to reduce the inflow of gases from the external atmosphere into the inner chamber. However, this measure results in a complicated structure of the seal, also leading to energy losses and additional heating during operation.

The object of the invention is therefore to provide a simply structured radial shaft seal of the kind mentioned in the opening paragraph that effectively counteracts the risk of eccentric running and extrusion into the gap, thus demonstrating an improved service life and furthermore permitting lower internal pressures.

According to the invention, the object is solved by the two membrane bodies being positioned at a distance from each other over their entire course, and by the supporting device includes a supporting body located between the membrane bodies.

A tighter fit of the membrane bodies in the radial shaft seal is ensured in that the membrane bodies are positioned at a distance from each other, meaning that direct mechanical coupling between them is avoided and they are instead supported individually by the supporting body. If the membrane bodies rest against each other, their necessarily effortless plastic deformability easily results in floating or reduced positional fixing of the membrane bodies. The consequence of this is that, when installed, the supporting body mechanically coupled to the membrane bodies must be retained at a correspondingly large distance from the shaft so that it cannot come into contact with the shaft. This, in turn, leads to corresponding limitation of the sealing capacity of the radial shaft seal, which means that, for example, only a certain negative pressure relative to the external atmosphere can be achieved because of this “leak”. In addition, the risk of eccentric running of the shaft relative to the supporting body, and of movement under pressure of the membrane bodies into the gap under pressure created by the pressure difference between inside and outside of the chamber, may be increased. The tighter fit of the membrane bodies makes it possible to position the supporting body closer to the shaft when installed, as a result of which the disadvantages described above, such as eccentric running of the shaft relative to the supporting body and thus movement of the membrane bodies into the gap, can be effectively counteracted. As a result, it is possible to achieve far lower negative pressures in the inner chamber before filling with the fluid medium, as well as a longer service life of the radial shaft seal in operation.

In accordance with the prior art, the radial shaft seal is of rotationally symmetrical design, with an axis of rotational symmetry that, in sealing position, should ideally coincide with the center longitudinal axis of the shaft. The supporting body preferably consists of a non-elastic polymer, preferably a thermoplastic, non-elastic polymer. A plastic made of polyphenylene sulfide (PPS) is preferred in this context. The supporting body is preferably injection-molded. The sealing membranes can be made of an elastomeric material that preferably contains particles of a lubricating solid. The particles can consist of graphite or polytetrafluoroethylene (PTFE). The space between the sealing membranes can be filled with a lubricant.

The supporting body can include an interior space in which the one membrane body, designed as the inner membrane body, is located. Further, the other membrane body can be located outside the interior space, and thus designed as the outer membrane body. The structural separation of the two membrane bodies from each other can thus be realized in simple fashion. In this context, the sealing membranes of the membrane bodies can in each case have a side face pointing away from the inner chamber that rests on a side face of the supporting body pointing towards the inner chamber.

In a preferred development of the radial shaft seal, the supporting body has a can-like, circular-cylindrical basic shape that forms the interior space and comprises the cylinder jacket wall and cylinder end walls. In this context, the cylinder end walls can each include a central, circular opening through which the shaft passes. To this end, when the radial shaft seal is installed, one cylinder end wall can be positioned facing towards the inner chamber as the inner cylinder end wall, and one cylinder end wall facing away from the inner chamber as the outer cylinder end wall. The sealing membrane of the outer membrane body can rest on an outer side of the inner cylinder end wall facing towards the inner chamber, while the sealing membrane of the inner membrane body preferably rests on an inner side of the outer cylinder end wall facing towards the inner chamber.

Partly to achieve a more stable arrangement of the membrane bodies, owing to greater positional fixation, provision can be made for the openings to be dimensioned in such a way that, when the radial shaft seal is in the sealing position, the size of the annular gap formed between the shaft and the inner side face of the respective opening is ≦0.05 mm, preferably ≦0.02 mm. An internal negative pressure of up to 20 mbar to 30 mbar in the interior space can then be achieved when pumping the air out of the interior space against the air flowing in through the annular gaps.

It is further considered to be an advantage that the opening edge of the respective cylinder end wall, bordering the annular gap and lying opposite the shaft, is chamfered in the direction of the inner chamber. In this way, the cylinder end wall can be designed to be mechanically more resistant to an internal positive pressure in the internal chamber.

For easier accessibility, the interior space can include an opening facility that is preferably provided outside the sealing position. This can be provided in that the supporting body can be parted in a parting plane, the parting plane running through the interior space. To this end, the supporting body can be divided into two supporting elements that rest against each other on a parting surface in positive and/or non-positive fashion when in the sealing position. The supporting elements are preferably held together loosely in the parting plane, preferably solely by being pressed against each other.

In the case of a cylindrical design of the supporting body, as described above, the parting surface can be located in an area in which the cylinder jacket wall and the inner cylinder end wall border on each other. In this way, the inner cylinder end wall is assigned to the one supporting element. Together with the outer cylinder end wall and the cylinder jacket wall, the other supporting element includes a cap-like form. As a result, both supporting elements are easy to manufacture.

To prevent slipping of the supporting elements when pressed together in the parting plane, the parting surface preferably includes a stepped profile. Particularly with the cylindrical form of the supporting body, this profile can include an alternating sequence of annularly arranged, circumferential partial surfaces for absorbing radial forces, and annularly arranged, radial partial surfaces for absorbing axial forces. To hold the supporting elements together better, the cylinder jacket wall and/or the inner cylinder end wall can have a greater wall thickness in the area of the parting surface.

An internal seat with a seating space for a retaining section of the inner membrane body can be provided in the interior space. The internal seat can include a hollow cylinder, extending axially from the inner cylinder end wall on the inside and positioned at a distance from the cylinder jacket wall. The seating space can thus be bordered by the hollow cylinder and the cylinder jacket wall in the radial direction, and by the inner cylinder end wall in the axial direction, whereas it is open towards the outer cylinder end wall. As a result the full surface of the retaining section can rest on the internal seat in mechanically stable fashion. To facilitate insertion of the retaining section of the inner membrane body, the hollow cylinder can be designed conically, in such a way that the seating space opens out slightly towards the rear cylinder end wall, preferably by just a few angular degrees. The hollow cylinder preferably extends up to, or almost up to, the sealing membrane, which, as already described, preferably rests on the inner side of the outer cylinder end wall, this making it possible to further increase the tight fit of the inner membrane body. This can also be increased in that the retaining section of the inner membrane body is located in the internal seat under surface pressure. The described arrangement of retaining section and sealing membrane, with a roughly orthogonal or orthogonal cross-section, implies a cap-like design of the inner membrane body that is easy to manufacture.

The outer membrane body likewise includes a cap-like form. In the cylindrical design of the supporting body, its sealing membrane preferably lies on the outer side of the inner cylinder end wall, whereas its retaining section reaches around the supporting body to such an extent that the retaining section lies on the outer side of the cylinder jacket wall and, at least in a radially outer annular area, on the outer cylinder end wall. As a result, the outer membrane body can be fitted over the supporting body, enabling the outer membrane body to be fixed in position on the supporting body in dimensionally stable fashion. Moreover, the outer membrane body can hold the two supporting elements together in the manner of a brace. For improved fixing and holding together, provision can be made for the outer membrane body to rest on the supporting body under elastic prestress. This can be accomplished by the outer membrane body being slightly smaller than the supporting body before being fitted.

For stronger fixing or anchoring of the membrane bodies on the supporting body, the latter can, in areas in which the membrane bodies rest on the supporting body, include ribs that engage grooves provided in the membrane body and matching the ribs. The inner cylinder end wall, including one or more circumferential ribs, can, for example, project radially beyond the cylinder jacket wall and engage a facing, circumferential groove in the outer membrane body with a profile that matches the rib(s).

The radial shaft seal can be assembled in the following steps: first, the inner membrane body with its retaining section is drawn axially over the hollow cylinder of the one supporting element, preferably until the face end of the retaining section lies on the inner side of the front cylinder end wall. In the next assembly step, the cylindrical supporting body is assembled in that the other supporting element with its cylinder jacket wall is slid axially over the retaining section of the inner membrane body, in which context the retaining section of the inner membrane body is preferably subjected to radial pressure. Finally, the outer membrane body is fitted over the assembled supporting body, as a result of which the latter is preferably pressed together axially and radially. Since the radial shaft seal can be held together elastically by the outer membrane body, and the individual parts of the radial shaft seal thus held together in the correct position, the radial shaft seal preassembled in this way can be stored and transported without difficulty. Since the individual parts are assembled loosely to form the radial shaft seal, it can easily be dismantled again, e.g. in order to replace the inner membrane body.

On the outer side, in the area in which it lies on the cylinder jacket wall, the retaining section of the outer membrane body can include ribs, arranged circumferentially and at a distance from each other. The ribs can extend radially outwards. In installed position, the ribs preferably extend towards the inner chamber at an acute angle to the longitudinal axis of the shaft. An interference fit of the radial shaft seal can be achieved by compression of the ribs during insertion of the radial shaft seal into the inner chamber, as described below.

The retaining section of the outer membrane body can be chamfered in a contact area extending from the cylinder jacket wall and towards the outer cylinder end wall, this facilitating insertion of the radial shaft seal into the inner chamber.

In a preferred development of the radial shaft seal, the sealing membrane of the outer membrane body can include a radially projecting collar with a surface pointing away from the inner chamber in the sealing position that rests flat on the inner side of the wall of the inner chamber at the receiving opening.

Further proposed is a radial shaft sealing system with a radial shaft seal according to an embodiment described above, and with a seal seat having the opening for receiving the radial shaft seal in the inner chamber. The radial shaft seal can preferably be mounted in the seal seat in an interference fit, the interference fit preferably also being produced via the ribs, as previously described.

The radial shaft seal can preferably be inserted into the receiving opening in a mounting direction corresponding to the direction of the pressure drop during normal operation. If the inner pressure chamber is used to store a fluid medium, this means that the mounting direction can be from the inner chamber towards the outside.

The radial shaft seal is preferably inserted so far into the receiving opening in the mounting direction that the surface of the radially projecting collar provided that faces away from the inner chamber in the sealing position makes contact with the inner side of the wall of the inner chamber at the receiving opening.

The present invention is described in more detail below on the basis of two practical examples illustrated in a drawing. The figures show the following:

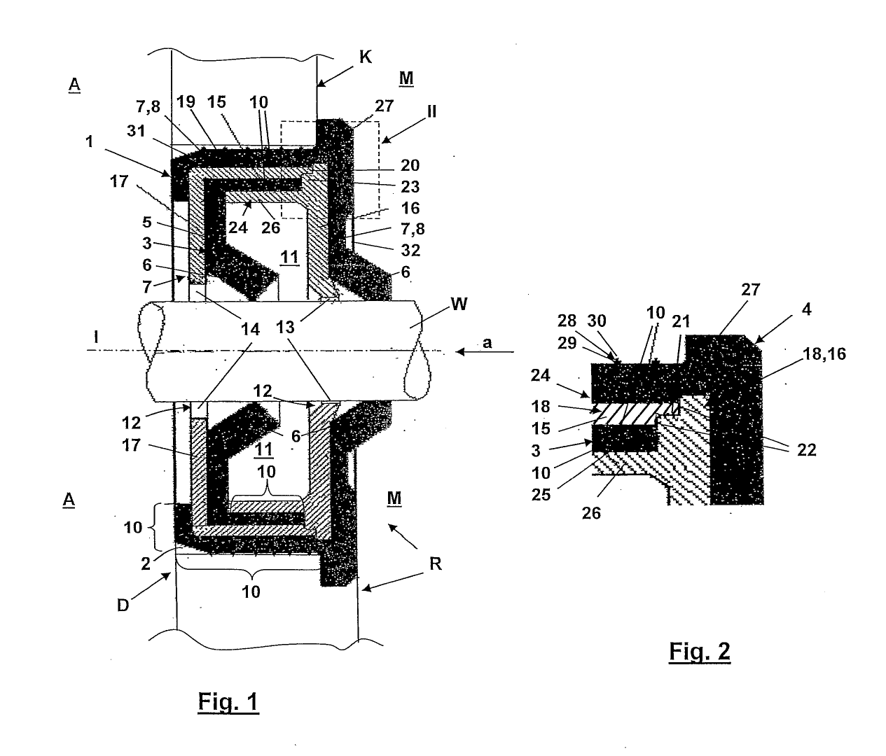

FIG. 1 A longitudinal section through a radial shaft sealing system with a first embodiment of a radial shaft seal,

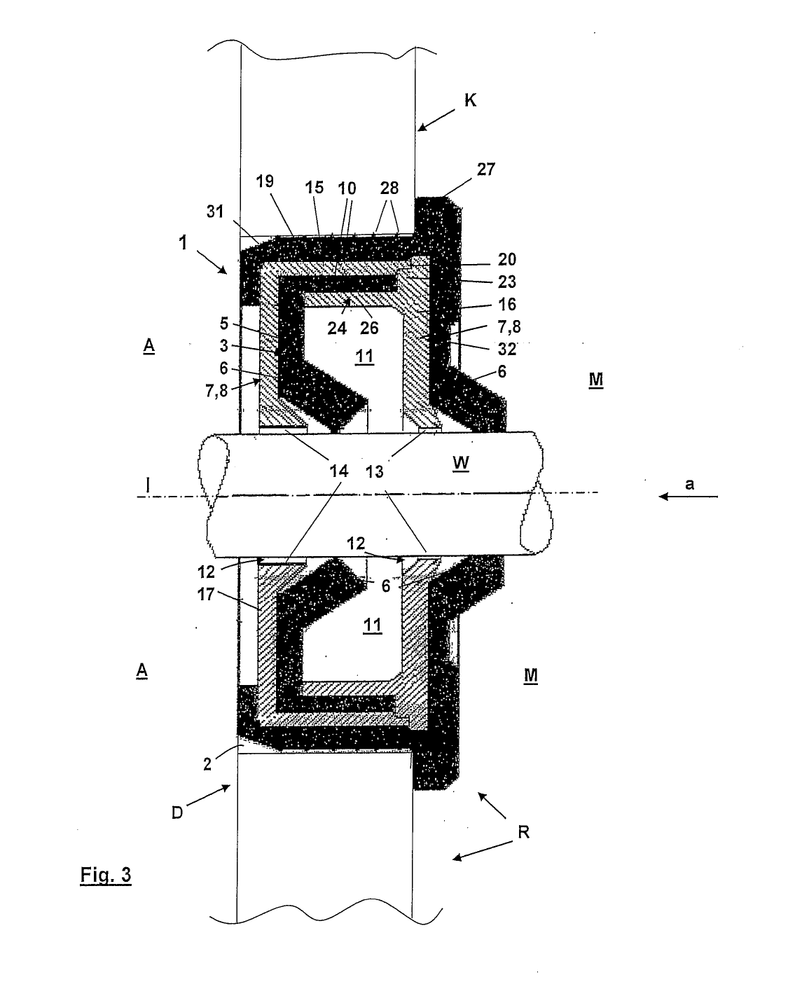

FIG. 2 An enlarged section II according to FIG. 1, and

FIG. 3 A longitudinal section through a radial shaft sealing system with a second embodiment of the radial shaft seal.

FIGS. 1 to 3 show two embodiments of a radial shaft sealing system R with a seal seat D including a receiving opening 2, and with a radial shaft seal 1 according to the invention for sealing a closed inner chamber K, filled with a fluid medium M, on a rotating shaft W that is guided out of inner chamber K through receiving opening 2, relative to an external atmosphere A, where inner chamber K is merely indicated in the drawings by a wall section with receiving opening 2. Radial shaft seal 1 is inserted into receiving opening 2 in an interference fit in a mounting direction a, running from the inside to the outside.

Radial shaft seal 1 includes two membrane bodies 3, 4, each having a sealing membrane 5 that is provided with a sealing lip 6 positioned obliquely to inner chamber K in the installed position, which rest on shaft W in sealing fashion at an axial distance from each other. Radial shaft seal 1 further comprises a supporting device 7 with a supporting body 8 having an interior space 11, on which sealing membrane 4 is supported on its side face 9 pointing away from inner chamber K. Radial shaft seal 1 with membrane body 3 and supporting device 7 is of rotationally symmetrical design, having its longitudinal axis I as the axis of rotational symmetry which, in the sealing position shown in FIGS. 1 and 3, coincides with the center longitudinal axis of shaft W. Both membrane bodies 3, 4 include a cap-like form, each with a retaining section 10 that extends radially outwards from sealing membrane 5 in the axial direction, and via which membrane bodies 3, 4 are each connected loosely to supporting body 8.

The two membrane bodies 3, 4 are positioned at a distance from each other over their entire course. Further, they are separated by supporting body 8, in that it is located between membrane bodies 3, 4. In that the necessarily relatively easily elastically deformable membrane bodies 3, 4 are prevented from resting on each other or coming into contact with each other, at least over a certain area, each instead being supported by rigid supporting body 8, a tighter fit of membrane bodies 3, 4 is ensured, and vibrations of one membrane body 3, 4 are not so readily transmitted to the other membrane body 4, 3 and thus to shaft W. As a result of this, the risk of eccentric running of shaft W, and of movement under pressure of membrane bodies 3, 4 into the gap, is reduced, this in turn increasing the service life of radial shaft seal 1.

Supporting body 8 having an interior space 11, in which the one membrane body, designed as inner membrane body 3, is located. For sealing positioning of sealing lip 6 of inner membrane body 3 on shaft W, interior space 11 is radially and circumferentially open towards shaft W, and closed off towards external atmosphere A and inner chamber K, except for a central, circular opening 12, through which shaft W is passed, or, when shaft W is inserted, except for an inner annular gap 13 relative to inner chamber K and an outer annular gap 14 relative to inner chamber K. The other membrane body, designed as outer membrane body 4, is located outside interior space 11.

Supporting body 8 has a can-like, circular-cylindrical basic shape that forms interior space 11 and comprises the cylinder jacket wall 15 and two cylinder end walls 16, 17, an inner cylinder end wall 16 relative to inner chamber K and an outer cylinder end wall 17 relative to inner chamber K, in which context opening 12 is in each case located at the center of cylinder end walls 16, 17.

Supporting body 8 is divided into two supporting elements, a first supporting element 18 and a second supporting element 19, that rest against each other on a parting surface 20 in positive and/or non-positive fashion when in the sealing position. Parting surface 20 separates cylinder jacket wall 15 from inner cylinder end wall 16, such that first supporting element 18 essentially comprises inner cylinder end wall 16, while second supporting element 19 essentially comprises outer cylinder end wall 17 and cylinder jacket wall 15, thus having a cap-like form.

Outer membrane body 4 reaches around supporting body 8. To this end, outer membrane body 4 rests on supporting body 8 under elastic prestress, with its sealing membrane 5 on the outside of inner cylinder end wall 16 and with its retaining section 10 on the outside of cylinder jacket wall 15 and outer cylinder end wall 17 in a radially outer area. As a result, supporting elements 18, 19, which actually remain loose, are pressed against each other and retained on parting surface 20.

Parting surface 20 includes a stepped profile with annularly arranged, circumferential partial surfaces 21 for transmitting radial forces, and annularly arranged, radial partial surfaces 22 for transmitting axial forces. As a safeguard, inner cylinder end wall 16 has a thicker area 23 in the area of parting surface 20.

Provided in interior space 11 is an internal seat 24, with a seating space 25 for retaining section 10 of inner membrane body 3, which is located in internal seat 24 in an interference fit with its entire surface, or essentially its entire surface, in contact and under pressure. Internal seat 24 includes a hollow cylinder 26, extending axially from inner cylinder end wall 16 on the inside and positioned at a distance from cylinder jacket wall 15, such that seating space 25 is bordered by hollow cylinder 26, cylinder jacket wall 15 and inner cylinder end wall 16, and open towards outer cylinder end wall 17. Seating space 25 extends axially up to sealing membrane 5 of inner membrane body 3.

In view of the previously described improved support of membrane bodies 3, 4 and the reduced risk of vibrations being transmitted between membrane bodies 3, 4, the gap width of one or both of gaps 13, 14 can be kept particularly small. In this context, the gap width of inner annular gap 13 is ≦0.02 mm. Deviating from the first embodiment of radial shaft seal 1 according to FIG. 1, outer gap 14 in the second embodiment of radial shaft seal 1 according to FIG. 3 likewise includes a gap width of ≦0.02 mm. The sealing properties of radial shaft seal 1 are decisively further improved thanks to these small gap widths, by means of which the associated sealing membrane 5 is further supported in the direction of shaft W. Further, the edge of the respective opening 12 that borders inner annular gap 13, and additionally outer annular gap 14 in the second embodiment, is chamfered in the direction of inner chamber K, as a result of which the respectively associated sealing lip 6 is supported better, thereby further reducing the risk of sealing lip 6 being pushed into annular gap 13, 14 under pressure created by the pressure difference between inside and outside of chamber K. The negative pressure thus achievable when pumping the air out of inner chamber K against the air flowing in through the annular gaps is 120 mbar at most.

Sealing membrane 5 of outer membrane body 4 includes a radially projecting collar 27, with a surface 28, pointing away from inner chamber K in the sealing position, for flat contact on the inner side of the wall of inner chamber K at receiving opening 2, which thus serves as a mechanical stop when inserting radial shaft seal 1 into receiving opening 2 in mounting direction a.

To encourage an interference fit of radial shaft seal 1 in receiving opening 2, retaining section 10 of outer membrane body 4 has, on the outer side in the area in which it lies on cylinder jacket wall 15, ribs 28 that are arranged circumferentially, at a distance from each other, and extend radially outwards. Ribs 28 are of stepped design, with a base 29 that tapers slightly conically towards retaining section 10 and an extension 30 projecting centrally therefrom, as a result of which ribs 28 can be bent over more easily when inserting radial shaft seal 1 into receiving opening 2 and are pressed more effectively against the inner wall in receiving opening 2 in an interference fit.

Provided on the outer side of sealing membrane 5 of outer membrane body 4 is an annular groove 32, which facilitates fitting of outer membrane body 4 over supporting body 8 with the enclosed inner membrane body 3.

To facilitate insertion of radial shaft seal 1 into receiving opening 2, retaining section 10 is chamfered in an area 31 located at the rear in mounting direction a.

### LIST OF REFERENCE NUMBERS

1 Radial shaft seal
2 Receiving opening
3 Inner membrane body
4 Outer membrane body
5 Sealing membrane
6 Sealing lip
7 Supporting device
8 Supporting body
9 Side face
10 Retaining section
11 Interior space
12 Opening
13 Inner annular gap
14 Outer annular gap
15 Cylinder jacket wall
16 Inner cylinder end wall
17 Outer cylinder end wall
18 Supporting element
19 Supporting element
20 Parting surface
21 Circumferential partial surface
22 Radial partial surface
23 Thicker area
24 Internal seat
25 Seating space
26 Hollow cylinder
27 Collar
28 Rib
29 Base
30 Extension
31 Area
32 Annular groove
a Mounting direction
A External atmosphere
D Seal seat
K Inner chamber
R Radial shaft sealing system
W Shaft
I Longitudinal axis

1. A radial shaft seal for sealing a closed inner chamber (K) capable of being filled with a fluid medium (M) on a rotating shaft (W) that is guided out of the inner chamber (K) through a receiving opening (2), relative to an external atmosphere (A), said seal comprising:
an inner membrane body (3) and an outer membrane body (4), each membrane body including a sealing membrane (5) having a sealing lip (6) positioned obliquely to the inner chamber (K), where the two sealing lips (6) can be positioned on the shaft (W) in sealing fashion at an axial distance from each other, and
a supporting device (7) for supporting the membrane bodies (3, 4) resting thereon, the supporting device (7) includes a supporting body (8) located between the membrane bodies (3, 4); and
wherein the two membrane bodies (3, 4) are positioned at a distance from each other over their entire course.

2. The radial shaft seal according to claim 1, wherein the supporting body (8) having an interior space (11) in which the inner membrane body (3) is located, and the outer membrane body (4) is located outside the interior space (11).

3. The radial shaft seal according to claim 2, wherein the supporting body (8) has a cylindrical shape that forms the interior space (11) and comprises
a cylinder jacket wall (15), and
cylinder end walls (16, 17), where the cylinder end walls (16, 17) each having a central, circular opening (12) through which the shaft (W) passes, and
when the radial shaft seal (1) is installed, one cylinder end wall is positioned facing towards the inner chamber (K) as the inner cylinder end wall (16), and one cylinder end wall facing away from the inner chamber (K) as the outer cylinder end wall (17).

4. The radial shaft seal according to claim 3, wherein the openings (12) are dimensioned in such a way that, when the radial shaft seal (1) is in the sealing position, the size of the annular gap (13, 14) formed between the shaft (W) and the inner side face of the respective opening (12) is ≦0.05 mm.

5. The radial shaft seal according to claim 3, wherein the opening edge of the respective cylinder end wall (16, 17), bordering the annular gap (13, 14) and lying opposite the shaft (W), is chamfered.

6. The radial shaft seal according to claim 3, wherein the supporting body (8) is divided into two supporting elements (18, 19) that rest against each other on a parting surface (20) in positive and/or non-positive fashion when in the sealing position.

7. The radial shaft seal according to claim 6, wherein the parting surface (20) is located in an area in which the cylinder jacket wall (15) and the inner cylinder end wall (16) border on each other.

8. The radial shaft seal according to claim 6, wherein the parting surface (20) includes a stepped profile having
annularly arranged, circumferential partial surfaces (21), and
annularly arranged, radial partial surfaces (22).

9. The radial shaft seal according to claim 7, wherein the cylinder jacket wall (15) and/or the inner cylinder end wall (16) includes a greater wall thickness in said area where the cylinder jacket wall and the inner cylinder end wall border each other.

10. The radial shaft seal according to claim 4, further comprising an internal seat (24) with a seating space (25) for a retaining section (10) of the inner membrane body (3) is provided in the interior space (11), where the internal seat (24) includes a hollow cylinder (26), extending axially from the inner cylinder end wall (16) on the inside and positioned at a distance from the cylinder jacket wall (15), and the seating space (25) is bordered by the hollow cylinder (26) and the cylinder jacket wall (15).

11. The radial shaft seal according to claim 10, wherein the sealing membrane (5) of the inner membrane body (3) rests against the inner side of the outer cylinder end wall (16), and in that the hollow cylinder (26) extends up to the sealing membrane (5).

12. The radial shaft seal according to claim 10, wherein the retaining section (10) of the inner membrane body (3) is located in the internal seat (24) under surface pressure.

13. The radial shaft seal according to claim 10, wherein the sealing membrane (5) of the outer membrane body (4) lies on the outer side of the inner cylinder end wall (16) and its retaining section (10) reaches around the supporting body (8) to such an extent that the retaining section (10) lies on the outer side of the cylinder jacket wall (15) and, at least in a radially outer annular area, on the outer cylinder end wall (17).

14. The radial shaft seal according to claim 13, wherein the outer membrane body (4) rests on the supporting body (8) under elastic prestress.

15. The radial shaft seal according to claim 13, wherein the retaining section (10) of the outer membrane body (4) includes ribs (28) arranged circumferentially and at a distance from each other, on the outer side in the area in which it lies on the cylinder jacket wall (15), said ribs extend radially outwards,
wherein when the outer membrane body (4) is installed, the ribs extend towards the inner chamber at an acute angle to the longitudinal axis of the shaft.

16. The radial shaft seal according to claim 13, wherein the retaining section (10) of the outer membrane body (4) is chamfered in a contact area extending from the cylinder jacket wall (15) and towards the outer cylinder end wall (17).

17. The radial shaft seal according to claim 3, wherein the sealing membrane (5) of the outer membrane body (4) includes a radially projecting collar (27) with a surface (F) pointing away from the inner chamber (K) in the sealing position that rests flat on the inner side of the wall of the inner chamber (K) at the receiving opening (2).

18. The radial shaft seal according to claim 1, wherein the supporting body (8) consists of a non-elastic, thermoplastic polymer.

19. A radial shaft sealing system with comprising:
a shaft seal (1) according to claim 1, and
a seal seat (D) having the opening (2) for receiving the radial shaft seal (1) in the inner chamber (K).

20. The radial shaft sealing system according to claim 19, wherein the radial shaft seal (1) is located in the seal seat (D) in an interference fit.

21. The radial shaft sealing system according to claim 19, wherein the radial shaft seal includes an outer membrane body (4) with a radially projecting collar (27), such that the radial shaft seal (1) can be inserted into the receiving opening (2) in a mounting direction (a), from the inner chamber (K) outwards, until the collar (27) comes into contact with a front surface of the seal seat (D), seen in the mounting direction (a).

22. The radial shaft seal according to claim 3, wherein the openings (12) are dimensioned in such a way that, when the radial shaft seal (1) is in the sealing position, the size of the annular gap (13, 14) formed between the shaft (W) and the inner side face of the respective opening (12) is equal to or less than 0.02 mm.
